(19) United States
(12) Patent Application Publication
(10) Pub. No.: US 2008/0293304 A1
(43) Pub. Date: Nov. 27, 2008

(54) Device for Use in a Cable Connection Arrangement and a Cable Connection Arrangement Having Such a Device

(76) Inventors: Torsten Friedrich, Munchen (DE); Richard Graf, Unterschleissheim (DE); Markus Hardi, Neubiberg (DE)

Correspondence Address: BARLEY SNYDER, LLC, 1000 WESTLAKES DRIVE, SUITE 275, BERWYN, PA, 19312, US

(21) Appl. No.: 12/122,931

(22) Filed: May 19, 2008

(30) Foreign Application Priority Data
May 22, 2007 (EP) 07010150.6

(51) Int. Cl. H01R 27/02

(52) U.S. Cl. 439/651

(57) ABSTRACT

A device for use in a cable connection includes a first section formed of a molded resilient material. The first section is provided with at least one opening extending there through for receiving a cable. A second section is formed of a molded resilient material. The second section is at least partially separated from the first section. The second section has at least one interface that lies opposite an interface of the first section that is mateable therewith. The interface of the second section and the interface of the first section have an intermediate space there between in an unmated position. The interface of the second section mutually abuts the interface of the first section in a mated position.

### CROSS-REFERENCE TO RELATED APPLICATIONS

This application claims the benefit of the filing date under 35 U.S.C. §119(a)-(d) of European Patent Application No. EP 07 010 150.6, filed May. 22, 2007.

### FIELD OF THE INVENTION

The present invention relates to a device for use in a cable connection arrangement, in particular at a connecting point between cables, comprising a molded body having at least one opening, into which a cable or part of a cable may be introduced and which extends through the molded body. The present invention further relates to a connection arrangement for the connection of at least one cable to an electrical connector having such a device.

### BACKGROUND

Connection or branch points, particularly of power cables, are produced under very diverse ambient conditions, for example outdoors, indoors or in installation spaces, it being necessary in each case to guarantee a high degree of electrical safety and resistance to environmental influences. Use is made for example of so-called cable jointing sleeves, with which for example three power cables are connected to one another, two cables usually extending in parallel on one side of the sleeve, up to the connector, while on the opposite side only a single cable is guided into the connector. In particular, to form such a cable connection arrangement, use is made of molded bodies, so-called devices, which are slipped onto a prepared cable prior to establishing the connection. In particular, such a device comprises a molded body having one or more openings, into each of which a cable is introduced and which extend in each case through the molded body.

Such a molded body for forming a device of a known design is shown by way of example in FIG. 5. A shown in FIG. 5, device 90 comprises a molded body 91 having openings 1, 2, which extend in each case through the molded body 91 and extend approximately parallel to each other. With the aid of the so-called push-on technique, the device 90 is pushed onto each of the cables so that the cables are introduced into the openings 1, 2. The objective is that in a final state there are, as far as possible, no air pockets at an interface between the cable and the molded body 91 of the device 90 in order to avoid the problem of partial discharges at such interfaces with air pockets. In order to achieve this objective, the openings 1, 2 have to fit almost positively onto an outer circumference of the cable that is to be introduced, this generally being achieved in that the openings 1, 2 are expanded during the pushing of the device 90 onto the cable or cables.

In this case, with a view to making assembly as easy as possible, it is advantageous if the push-on forces required for this purpose are kept as low as possible. It is further advantageous if the device 90 may be used in a wide field of application and may therefore be fitted onto cables of differing outer diameter. This means, however, that the openings 1, 2 have to be dimensioned to suit the smallest cable diameter to be used and, if the device 90 is used on larger cable diameters, correspondingly more expansion has to occur to allow the device 90 to be pushed onto larger cables as well. In the case of the device 90, it is moreover necessary for an intermediate space 92 (interpolar gap) between the openings 1, 2 into which the cables are introduced, to be completely filled with insulating material so as to exclude air pockets and prevent partial discharges in this region and hence guarantee the electrical function of the connection arrangement. In the case of the molded part in the form of the device 90 shown here, this may be guaranteed by the use of elastomer materials that have a substantially oval cross section with two round recesses for the cables.

Once the cables have been introduced into the openings 1, 2, a sleeve body of a conventional construction is fitted over the cables and over the device 90 and also overlaps the electrical connector to form a connection to a further cable. When connecting the device 90 to the fitted sleeve body the objective is likewise for there to be substantially no air pocket between the interfaces of the device 90 and the sleeve body in order to prevent partial discharges at this point as well. For this purpose, it is necessary for the sleeve body to be able to fit well onto the outer surface of the device 90. It is therefore advantageous if the external shape of the device 90 is substantially retained even after the cables have been introduced into the openings 1, 2.

During the pushing of the device 90 onto the cable, displacements of material in the intermediate space 92 between the openings 1, 2 may occasionally occur in the course of expansion of the corresponding opening, with the result that the external shape of the device 90 may vary. However, since for all possible cable cross sections it is also a requirement that the external shape of the device 90 remain substantially oval and/or bellied in order to prevent air pockets between the device 90 and the sleeve body, greater wall thicknesses of the molded body of the device 90 are occasionally necessary. This, however, leads to the disadvantage that more material has to expand during introduction of the cable, conflicting with the objective of lower push-on forces. It is therefore necessary to arrive at a compromise involving a limited field of application and only just acceptable push-on forces.

### SUMMARY

It is therefore an object of the present invention is to provide a device for use in a cable connection arrangement, in particular at a connecting point between at least two cables, of the initially described type, with which a molded body for forming an device may be provided, which allows a relatively wide field of application in terms of various cable cross sections, combined with acceptable push-on forces.

This an other objects are achieved by a device for use in a cable connection comprising a first section formed of a molded resilient material. The first section is provided with at least one opening extending there through for receiving a cable. A second section is formed of a molded resilient material. The second section is at least partially separated from the first section. The second section has at least one interface that lies opposite an interface of the first section that is mateable therewith. The interface of the second section and the interface of the first section have an intermediate space there between in an unmated position. The interface of the second section mutually abuts the interface of the first section in a mated position.

### BRIEF DESCRIPTION OF THE DRAWINGS

FIG. 1A is perspective view of a device for use in a cable connection arrangement according to a first embodiment of the invention.

FIG. 1B is plan view of the device of FIG. 1A.

FIG. 1C is perspective view of a device for use in a cable connection arrangement according to a second embodiment of the invention.

FIG. 1D is perspective view of a device for use in a cable connection arrangement according to a third embodiment of the invention.

FIG. 1E is perspective view of a device for use in a cable connection arrangement according to a fourth embodiment of the invention.

FIG. 1F is perspective view of a device for use in a cable connection arrangement according to a fifth embodiment of the invention.

FIG. 1G is plan view of a device for use in a cable connection arrangement according to a sixth embodiment of the invention.

FIG. 2A is an exploded view of a device for use in a cable connection arrangement according to a seventh embodiment of the invention.

FIG. 2B is a perspective view of the device of FIG. 2A.

FIG. 2C is an exploded view of a device for use in a cable connection arrangement according to an eighth embodiment of the invention.

FIG. 2D is a perspective view of the device of FIG. 2C.

FIG. 3 is an exploded view of a device for use in a cable connection arrangement according to a ninth embodiment of the invention.

FIG. 4 is a perspective view of an embodiment of a cable connection arrangement for connecting a plurality of cables using one or more of the devices according to FIGS. 1A-3.

FIG. 5 is a device for use in a cable connection arrangement according to the prior art.

### DETAILED DESCRIPTION OF THE EMBODIMENT(S)

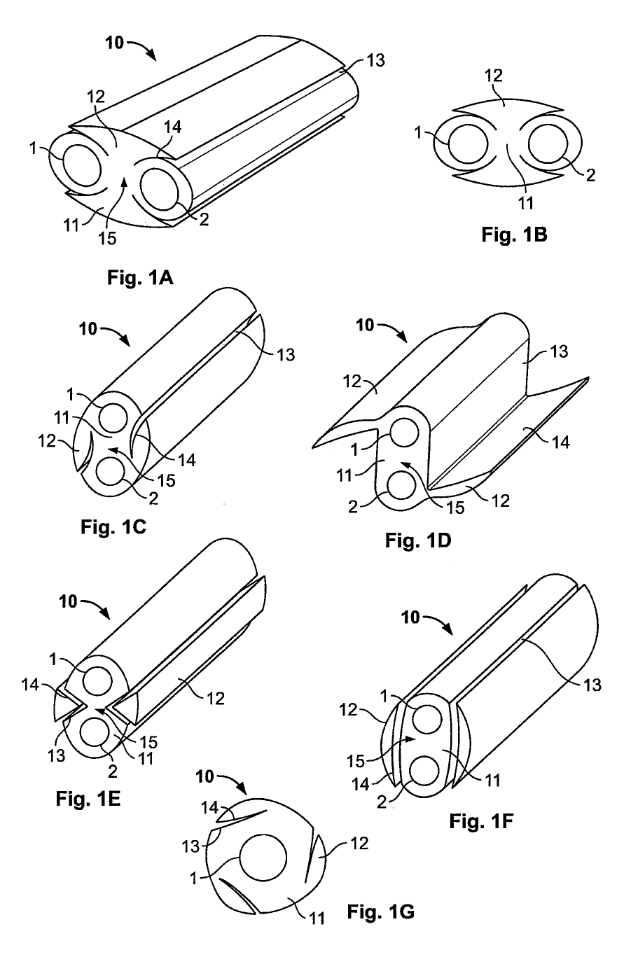

FIGS. 1A-1G show first through sixth embodiments of a device 10 for use in a cable connection arrangement. A common feature of the embodiments of the device 10 shown in FIGS. 1A-1G is that the device 10 has a molded body comprising a first section 11 formed of a resilient material and a second section 12 formed of a resilient material, wherein the second section 12 adjoins the first section 11. In the embodiments of the device 10 shown in FIGS. 1A-1D and 1G, the second section 12 is partially attached to the first section 11, and in the embodiments of the device 10 shown in FIGS. 1E-1F, the second section 12 is separate from the first section 11. The device 10 further has openings 1, 2 in the first section 11 that extend substantially parallel through the molded body and are configured to receive a cable or a portion of a cable therein. As shown in the embodiment in FIG. 1G, the device 10 may also be formed with only one of the openings 1 being provided in the first section 11.

With respect to the embodiments of the device 10 shown in FIGS. 1A-1D and 1G, in addition to molding the first section 11 and the second section 12 to form the desired shape, various techniques for cutting the first section 11 and the second section 12 to form the desired shape may be considered. For example, the first section 11 and the second section 12 may be cut by a single-blade cutting, a circular long blade, slitting rollers, high-pressure water jet cutting and/or water-jet-cooled laser cutting. The second section 12 may therefore be at least partially detached in diverse ways from a homogeneous molded body, thereby leaving the first section 11 of reduced material thickness, which surrounds the openings 1, 2. With respect to the embodiments of the device 10 shown in FIGS. 1E-1F, the first section 11 and the second section 12 may be manufactured separately.

As shown in FIGS. 1A-1G, the first section 11 has an interface 13, and the second section 12 has an interface 14. The interfaces 13, 14 lie opposite one another such that an intermediate space is formed there between in an unmated position and are configured to mutually abut one another. The interfaces 13, 14, upon fitting a sleeve body onto the device 10, mutually abut such that there is substantially no air pocket there between in a mater position. Thus, partial discharges at the interfaces 13, 14 are prevented by minimizing the air trapped between the interfaces 13, 14. Although the objective in this case is for the intermediate space to be free of air pockets, because of material influences and/or slight form variations it may be possible that tiny quantities of air are still present in sub-regions of the intermediate space. The first section 11 and the second section 12, via appropriate shaping of the interfaces 13, 14, are constructed in such a way that upon enclosure by a sleeve body the first section 11 and the second section 12 of the molded body are pressed against one another to form a compact molded body formation, thereby leading to the same electrical properties as the homogeneous device of the prior art shown in FIG. 5.

In the embodiments of the device 10 shown in FIGS. 1A-1F having the openings 1, 2, an intermediate region 15 is provided between and in a vicinity of the openings 1, 2, and the cross-sectional area of the first section 11 is reduced relative to the cross-sectional area of the entire molded body. In the case of a substantially oval or bellied shape of the molded body, the intermediate region 15 of the entire arrangement of the molded body has a larger diameter relative to outer regions of the molded body on an opposite side of each of the openings 1, 2. Thus, by providing on the first section 11, the second section 12 for the pushing-on of the cable, material is deliberately removed so that less material has to be expanded during the pushing-on of the cable. On the one hand this reduces the required push-on forces and, on the other hand, with a lower material thickness it is guaranteed that, when the sleeve body is fitted, the substantially oval or bellied final shape of the molded body is retained, resulting in an air-pocket-free connection between molded body and sleeve body. The sleeve body fitted during the subsequent installation process presses the separate or protruding second sections 12 in such a way against the first section 11 that the intermediate space is substantially free of air pockets. Chambers or rounded portions at the ends of the molded parts are also helpful for the escape of the air.

Thus, the basic idea underlying the first through sixth embodiments of the device 10 shown in FIGS. 1A-1G is that with suitable shaping of the second section 12, the material thickness of the molded body that is to be stretched during introduction of the cable into one of the openings 1, 2 is correspondingly reduced, thereby making it possible to reduce the push-on forces during introduction of the cable into one of the openings 1, 2. A cold-shrink sleeve, or alternatively a heat-shrink sleeve, used in the subsequent installation process presses the separate or protruding second section 12 in such a way against the first section 11 of the molded body that the intermediate space is substantially free of air pockets.

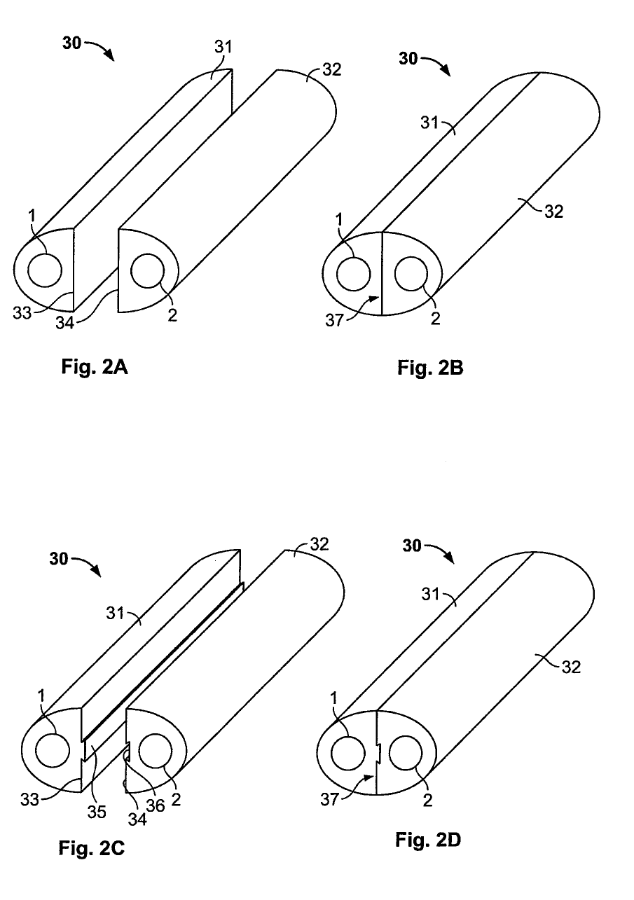

FIGS. 2A-2D show seventh through eighth embodiments of a device 30 for use in the cable connection arrangement. A common feature of the embodiments of the device 30 shown in FIGS. 2A-2D is that the device 30 has a first section 31 separate from a second section 32. The first section 31 and the second section 32 are both formed by molding. The first section 31 has an opening 1 extending there through, and the second section 32 has an opening 2 extending there through. The first section 31 has an interface 33 that lies opposite an interface 34 of the second section 32. An intermediate region 37 is formed there between. The first section 31 and the second section 32 mutually abut at the interfaces 33, 34. In the embodiment of the device 30 shown in FIGS. 2A-2B, the first section 31 and the second section 32 have an approximately identical cross-sectional area and are substantially identical molded parts. The first section 31 and the second section 32 are pushed individually onto a cable when in an unmated position. In the intermediate region 37 between the openings 1, 2 the cross-sectional area of either the first section 31 or the second section 32 is reduced compared to the cross-sectional area of the entire molded body, so the material thickness to be expanded is reduced. In this case, a single molded part requires a much lower push-on force than a single molded body having the openings 1, 2. By the contact pressure that arises during the subsequent installation process of the sleeve body, the first section 31 and the second section 32 are pressed against one another in such a way that there are substantially no longer any air pockets in the intermediate space between the interfaces 33, 34 in a mated position.

So that the first section 31 and the second section 32 are possibly better positioned relative to one another after the push-on process, in the embodiment of the device 30 according to FIGS. 2C-2D, a mechanical fastening device is provided, which is disposed at the interfaces 33, 34 of the first section 31 and the second section 32. The fastening device is provided in this case by a so-called dovetail groove 36 in the interface 34 into which a corresponding tongue 35 on the interface 33 engages. The provision of such a fastening device improves the mechanical connection between the first section 31 and the second section 32, with the result that air pockets at the interfaces 33, 34 may be comparatively reliably avoided.

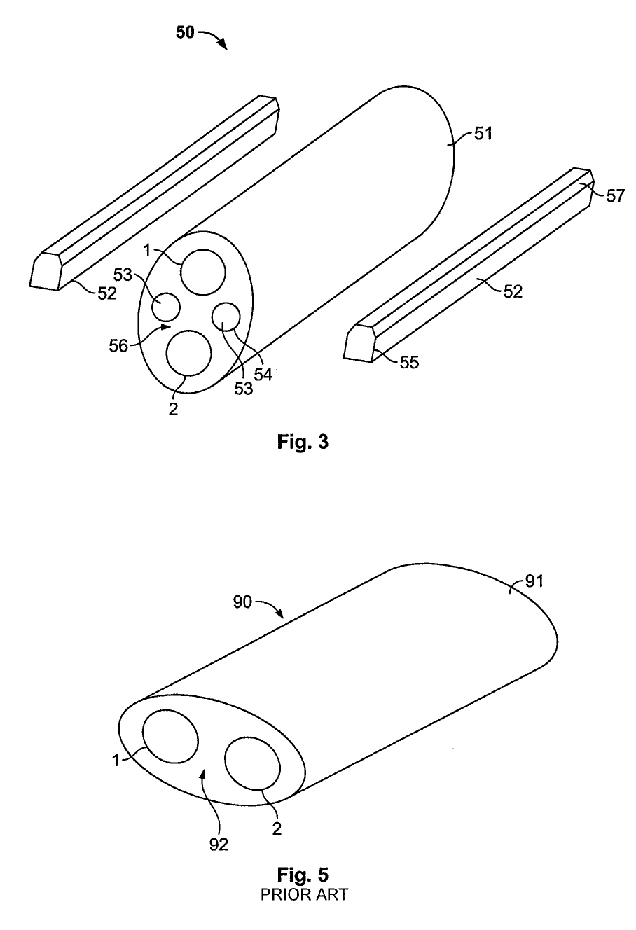

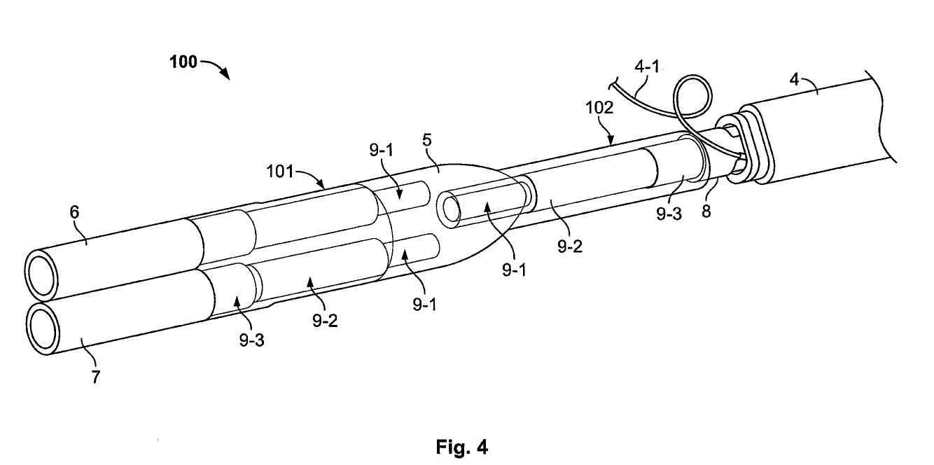

FIG. 3 is a ninth embodiment of a device 50 for use in the cable connection arrangement. The device 50 comprises a first section 51 molded from a resilient material. The first section 51 is provided with openings 1, 2, into which a cable may be introduced. The first section 51 is also provided with recesses 53, which are closable in each case by a second section 52 formed separate from the first section 51. The second sections 52 are molded to have a substantially elongated shape and in cross section each has an area that is greater than the cross-sectional area of the recess 53. The second section 52 is separate from the first section 51 in an unmated position. Thus, during the introduction of the second sections 52 into the recesses 53, the recesses 53 expand so that at interfaces 54, 55 between the first section 51 and the second section 52 there is substantially no air pocket. In this case, the cross-sectional area of the second sections 52 need not be adapted to the cross-sectional area of the recesses 53. Additionally, at least one rounded portion and/or chamfer 57 may be disposed on at least one end of each of the interfaces 54, 55 in order to make it easier for air to escape when the second sections 51, 52 are brought together. A rounding-off of the edges of the second sections 52 may improve a positive abutment with inner surface of the recess 53.

The embodiment of the device 50 according to FIG. 3 likewise has the objective of reducing the material-filled cross-sectional area of the first section 51 in the intermediate region 56 between the openings 1, 2 relative to the cross-sectional area of the entire molded body with the second sections 52. In this case, the material thickness in the intermediate region 56 is reduced by providing the recesses 53. The recesses 53 may have various shapes, such as circular or rectangular shapes. By virtue of the purposeful removal of material, the recesses 53 help to reduce the push-on force. Furthermore, the first section 51 may be adapted in shape so as to provide an optimum substantially bellied or oval shape for the sleeve body that is to be fitted. After the process of pushing the first section 51 onto the cable or cables, the second sections 52 are pushed into the recesses 53 into a mated position. Because the second sections 52 have, compared to the recesses 53, a shape or cross-sectional area which is larger by a defined amount but which need not be identical and contact pressure arises during the subsequent installation process of the sleeve body, in particular in the form of a cold-shrink sleeve, air pockets are prevented.

In FIG. 4 an embodiment of a cable connection arrangement 100 for the connection of cables 6, 7 and 8. In the illustrated embodiment, the cables 6, 7 and 8 are connected to one another by an electrical connector 5. The cables 6, 7 that comprise electrical conductors 9-1, cable insulation 9-2, and a cable semi-conductive layer 9-3 are introduced into a device 101. The cable 8 that comprises electrical conductors 9-1, cable insulation 9-2, and a cable semi-conductive layer 9-3 is introduced into a device 102. The devices 101, 102 may be used with any of the devices 10, 30, 50. In the electrical connector 5, the electric conductors 9-1 emerging from the cables 6, 7, 8 are connected to one another. A sleeve body 4, illustrated herein as a cold-shrink sleeve, is disposed at least partially around the molded body of one of the devices 101, 102, in a form such that at least in sub-regions between the molded body and the sleeve body there is substantially no air pocket. In this way, partial discharges in this region of the cable connection arrangement 100 are also prevented. By virtue of the sleeve body 4 being disposed and shrunk on (by removing litz wire 4-1) over the molded bodies of the devices 101, 102, the different parts of the respective molded bodies are pressed against one another in the manner described above. Although the arrangement according to FIG. 4 is used to connect a plurality of cables to one another, in connection with the present invention it is in principle also possible to provide a molded body generally for connecting one cable to an electric conductor, either of another cable or of any electrical device.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A device for use in a cable connection, comprising:
a first section formed of a molded resilient material, the first section provided with at least one opening extending there through for receiving a cable;
a second section formed of a molded resilient material, the second section being at least partially separated from the first section, the second section having at least one interface that lies opposite an interface of the first section that is mateable therewith; and
the interface of the second section and the interface of the first section having an intermediate space there between in an unmated position and the interface of the second section mutually abutting the interface of the first section in a mated position.

2. The device of claim 1, wherein the second section is completely separated from the first section.

3. The device of claim 2, wherein the first section further comprises at least one recess that extends there through that receives the second section.

4. The device of claim 3, wherein the second section has a cross sectional area greater than the cross sectional area of the recess.

5. The device of claim 3, wherein the second section includes a chamfer on at least one edge of the interface.

6. The device of claim 2, wherein the second section is provided with at least one opening extending there through for receiving another cable.

7. The device of claim 2, wherein the second section is fastened to the first section by a fastening device.

8. The device of claim 1, wherein the second section is at least partially separated from the first section proximate the opening.

9. The device of claim 1, further comprising a sleeve body that encloses at least a potion of the first and second sections, the sleeve body pressing the interfaces of the first and second sections into the mated position.

10. The device of claim 1, wherein the device is substantially oval shaped.
